(19) United States
(12) Patent Application Publication
(10) Pub. No.: US 2024/0210303 A1
(43) Pub. Date: Jun. 27, 2024

(54) Methods And Systems For Implementing Single Photon Avalanche Diodes For Flow Cytometry

(71) Applicant: Life Technologies Corporation, Carlsbad, CA (US)

(72) Inventors: Daniel N. Fox, Bellvue, CO (US); Susan Hunter, Fort Collins, CO (US); Samuel Schonsberg, Fort Collins, CO (US)

(21) Appl. No.: 18/394,280

(22) Filed: Dec. 22, 2023

Related U.S. Application Data
(60) Provisional application No. 63/476,976, filed on Dec. 23, 2022.

(51) Int. Cl. G01N 15/1434; G01N 15/1429

(52) U.S. Cl. CPC G01N 15/1434; G01N 15/1429; G01N 2015/144

(57) ABSTRACT

Methods and systems for implementing single-photon avalanche diodes for flow cytometry are described herein. In one aspect, a computer-implemented method can include receiving one or more light signals at a point in time, wherein each light signal is captured by a respective pixel of a single-photon avalanche diode (SPAD) array; determining a number of activated pixels for the SPAD array during the point in time; and based on the number of activated pixels of the SPAD detector for the point in time, adjusting a count of light signals captured by the SPAD detector for the point in time.

### CROSS-REFERENCE TO RELATED APPLICATIONS

This application claims priority to and the benefit of U.S. Provisional Application No. 63/476,976, “Methods and Systems for Implementing Single Photon Avalanche Diodes for Flow Cytometry,” filed Dec. 23, 2022, the entirety of which application is incorporated herein by reference for any and all purposes.

### TECHNICAL FIELD

The present invention relates generally to florescence detection, and more particularly, to single photon avalanche diodes (SPADs).

### BACKGROUND

Flow cytometry systems typically require optical detectors capable of detecting light over a broad dynamic range (e.g., of at least 5 decades), including for light levels down to just a few photons. Additionally, these light pulses may be as short as 0.5 us, requiring a high bandwidth to accurately characterize the pulse. This has traditionally required a photo multiplier tube (PMT) for the detector and PMTs have served well in many instruments. However, PMTs can be quite expensive, especially those configured to detect photons in the wavelength range extending beyond 750 nm.

Multiple technologies have attempted to replace the PMT, but have been unable to match in terms of performance. Multi-pixel photon counter devices (MPPCs), also called Silicon Photo Multipliers (SiPMs), have excellent gain and bandwidth but have noise that is much higher than a PMT and also have linearity constraints. Avalanche photodiodes (APDs) have excellent photon detection efficiency but suffer from very low gain which reduces bandwidth and also appear to have linearity limitations. Direct photon counting with single photon avalanche diodes (SPADs) may be able to bypass these issues, but even the fastest SPADs are orders of magnitude too slow to be able to accurately count across the dynamic range requirements at the necessary bandwidths.

Further, flow cytometer instruments have evolved over the years to have more and more detectors in order to allow for more multiplexed experiments. The architecture of these systems continue to grow in size to be able to accommodate 2 trends: (a) a larger quantity of fluorescence detectors from a single laser excitation source and (b) a larger quantity of lasers that interact with the sample at spatially separated locations. If single detectors are utilized, then the instrument often grows quite large as the detector count increases. The use of multiple detectors assembled in a linear fashion has become more common on instruments to help with distribution of the full range of fluorescence signals from a single laser excitation. This suffers from several problems. (1) The detector spacing dictates the wavelength center and bandwidth for each channel (if a diffraction grating or prism is used for dispersion) (2) The settings for the detector array do not have the same flexibility in terms of gain and material composition to optimize the signal across all the channels as do the individual detectors (with given gains and peak wavelength sensitivities). Another approach to reducing the space needed for detectors has been to share a single detector to detect the light from multiple interrogation positions. This technique uses the arrival time to assign the signal to the appropriate laser, but also suffers from the problem that the settings must be a compromise between the signals detected across all the lasers and therefore, can suffer from saturation and/or not enough gain in selection of the gain setting. In addition, the sample must be run at low concentration to be sure to not have coincidence (which means that different cells hit different lasers at the same time so that there is signal mixing on the single detector).

### SUMMARY

Methods and systems for implementing single-photon avalanche diodes for flow cytometry are described herein. In one aspect, a computer-implemented method can include receiving one or more light signals at a point in time, wherein each light signal is captured by a respective pixel of a single-photon avalanche diode (SPAD) array; determining a number of activated pixels for the SPAD array during the point in time; and based on the number of activated pixels of the SPAD detector for the point in time, adjusting a count of light signals captured by the SPAD detector for the point in time. In addition, an assemblage of SPADS can be integrated in a single device with a separation of individual sensors relating to the separation and quantity of the interrogation points in the flow channel.

### BRIEF DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 depicts a flow cytometry system according to the present disclosure.

FIG. 2 depicts a SPAD array according to the present disclosure.

FIG. 3 depicts a SPAD detector according to the present disclosure.

FIG. 4 depicts a graph of simulated detection counts for SPAD arrays according to the present disclosure.

FIG. 5 depicts a graph of simulated detection counts for SPAD arrays according to the present disclosure.

FIG. 6 depicts a graph of simulated detection counts for SPAD arrays according to the present disclosure.

FIG. 7 depicts a graph of simulated detection counts for SPAD arrays according to the present disclosure.

FIG. 8 depicts a graph of detector photon detection efficiency (PDE) for different wavelengths according to the present disclosure.

FIG. 9 depicts a chart of fluorescence bands for a flow cytometer according to the present disclosure.

FIG. 10 depicts a chart of fluorescence bands for a flow cytometer according to the present disclosure.

FIGS. 11A-D depict a chart of fluorescence bands for a flow cytometer according to the present disclosure. FIG. 11A describes detection across the range of 300-600 nm. FIG. 11B describes detection across the range of 700-900 nm. FIGS. 11C and 11D demonstrates an exemplary implementation of 21-detector arrays.

FIG. 12 depicts a typical setup for a flow cytometry system.

FIG. 13 depicts a model of a flow cytometry system, where a fluorescence detection portion is placed within the imaging and magnification part of the collection lens. In addition, there is a primary optical filter just after the lens that is used to direct the individual laser light out of the main optical path and to a separate physical location for the purpose of scatter detection.

FIG. 14 depicts a flow cytometry design shown with a flexible number of pick-off optics to separate the focusing light into separate areas to be further divided and allowed to come to a focus onto multiple detector arrays simultaneously.

FIG. 15 depicts a graph of efficiency for a diffraction grating according to the present disclosure.

FIG. 16 depicts SPAD arrays according to the present disclosure.

### DETAILED DESCRIPTION OF ILLUSTRATIVE EMBODIMENTS

The present disclosure may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable, and it should be understood that steps can be performed in any order. Any documents cited herein are incorporated by reference in their entireties for any and all purposes.

It is to be appreciated that certain features of the invention which are, for clarity, described herein in the context of separate embodiments, can also be provided in combination in a single embodiment. Conversely, various features of the invention that are, for brevity, described in the context of a single embodiment, can also be provided separately or in any subcombination. Further, reference to values stated in ranges include each and every value within that range. In addition, the term “comprising” should be understood as having its standard, open-ended meaning, but also as encompassing “consisting” as well. For example, a device that comprises Part A and Part B can include parts in addition to Part A and Part B, but can also be formed only from Part A and Part B.

Methods and systems for implementing Single photon avalanche diodes (SPADs) in flow cytometry are described herein. SPADs typically are ill-suited for use as a detector in flow cytometry systems, due to high bandwidth and broad range requirements for flow cytometry detectors. SPADs can include pixel reset times that can limit the bandwidth of the SPAD. By accounting for a number of pixels within their respective reset time at a point in time when the SPAD captures light signals, the unavailable or activated pixels can be corrected for, such that a count of value of the captured light signals can be adjusted based on the activated pixels. Thus, the adjusted count can be a more accurate reflection of light received by the SPAD at a given time, even when some SPAD pixels cannot detect light at the given time (due to resetting). The methods described herein can thus increase the bandwidth of a SPAD, which can allow for SPADs to be utilized in higher-bandwidth applications.

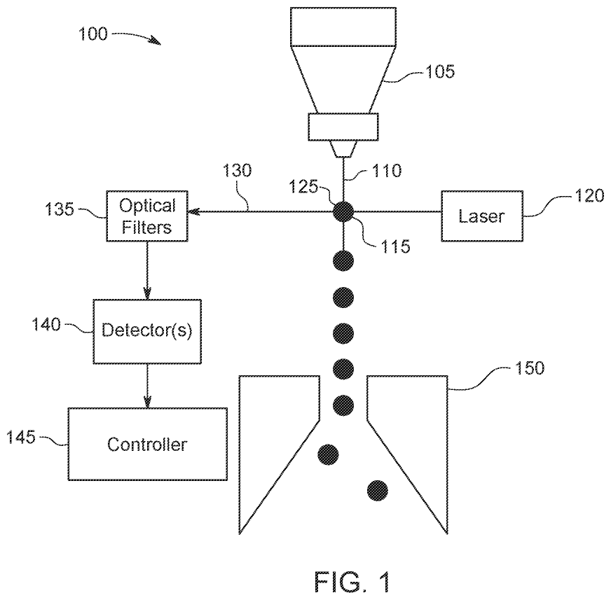

FIG. 1 depicts a flow cytometry system 100 according to the present disclosure. A sample can be sent through a nozzle 105 under pressurized conditions and can create a stream 110 at the output of the nozzle 105. The stream 110 breaks off into a series of droplets 115. Laser 120 can irradiate cells within the sample at interrogation site 125. Depending upon the type of cell that is irradiated by the laser 120, the cell can generate an optical response. The optical response can be forward scattered light or forward fluorescent emissions 130. Alternatively, or in addition, the response of the cell to the irradiation by laser 120 can be side-scattered light, or side fluorescent emissions. These responses are transmitted through optical filters 135 to detector 140.

The detector 140 can generate output signals that have a shape and magnitude that is indicative of the intensity of the light collected from the cell, at the specific frequencies of the optical filters 135. In some cases, the controller 145 can generate an event data signal based on the output signals received from the detector 140. For example, the event data signal can include a time stamp to identify the data with a particular cell. In some cases, the event data signal can include sorting information. For example, the controller 145 can implement sorting logic to perform sort decisions that are based upon the biological response of the particular types of cells that are being sorted. Statistical calculations of the likelihood of an event belonging to a certain population can be used for making the sort decision. The event data signal can be used to charge the stream via nozzle 105 prior to breaking off from the stream 110 such that deflector plates 150 can deflect the charged droplets (e.g., for sorting purposes). In some cases, the output signals from the detector 140 can include a photocount value. In some cases, the controller 145 can adjust the photocount value, which will be described in more detail.

The disclosure provided herein is not limited to the particular flow cytometry system 100 depicted in FIG. 1, and is used for illustrative purposes. For example, the methods described herein can be implemented by a flow cytometry system having various lasers of different wavelengths, various optical filters for filtering or directing emissions, various deflector plates or mechanisms for sorting samples (if any), and the like. In addition, this disclosure may be implemented in flow cytometry instruments capable of cell sorting and scanning instruments.

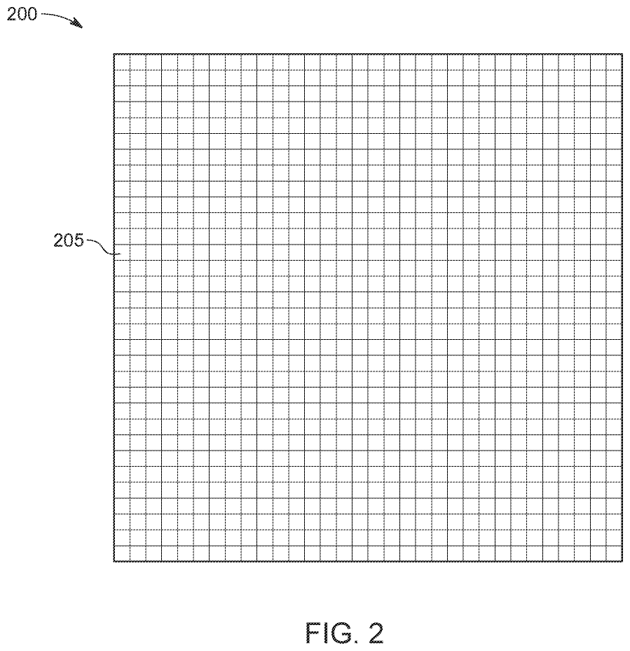

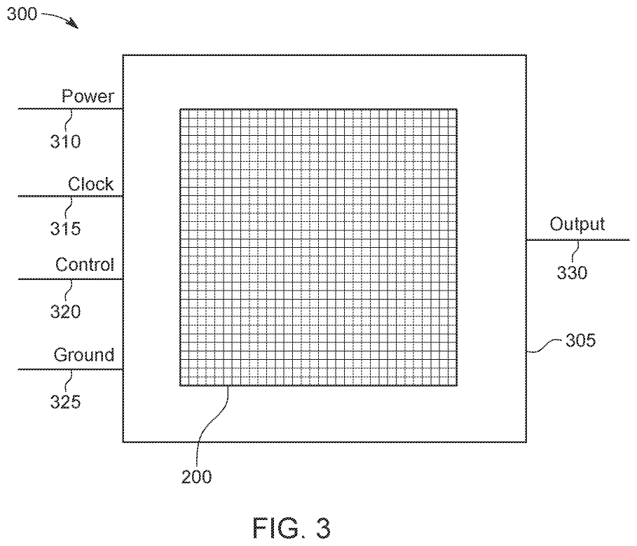

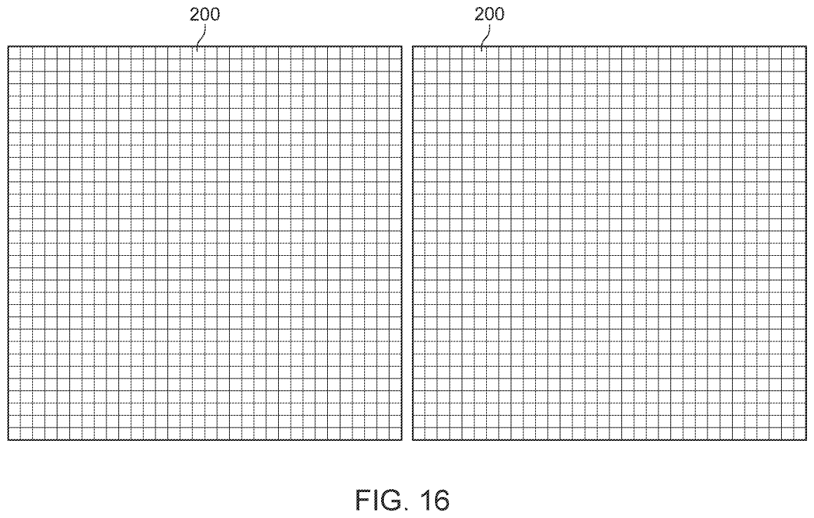

FIG. 2 depicts a SPAD 200 that can be implemented according to the disclosure described herein. FIG. 2 depicts a top perspective view of the SPAD, such that the SPAD pixels 205 are depicted. The SPAD 200 can include a number of pixels 205, that can be arranged in a variety of configurations. For example, the SPAD 200 is depicted as having a generally square shape (e.g., 32×32 pixels); however, one skilled in the art will understand that the SPAD is not limited to the shape depicted in FIG. 2. In some cases, each respective pixel 205 can be uniform in shape, and can form a square top surface profile; however, the pixel shapes and dimensions are not limited to those depicted in FIG. 2. Further, each SPAD 200 can be a SPAD array as described in the disclosure provided. For example, in some cases, a SPAD array can include a plurality of pixels that correspond to an underlying electronics component, such as those described in FIG. 3. In some cases, multiple SPAD arrays can be incorporated to function as a particular SPAD. For example, multiple SPAD arrays can be positioned such that an edge of a particular SPAD array can be flush with an edge of another SPAD array, which can increase the size of the SPAD array along a given dimension or dimensions(e.g., as shown in FIG. 16).

Each respective pixel 205 can be capable of becoming activated by capturing a light signal, such as a photon, at a given time. The pixel 205 can transfer an electronic signal resulting from the captured light signal to underlying electronics. Thus, at a given time, the SPAD 200 can act as a photocounter, where each pixel 205 is capable of capturing a respective light signal, and the aggregated count of captured light signals at a given time can act as an indicator of light intensity experienced by the SPAD.

However, each pixel 205 can experience a reset time, where the pixel 205 is unable to capture a light signal after previously being activated by capturing a light signal. For example, a reset time can include 10 ns, where the pixel is unable to capture a light signal. In some cases, the SPAD pixels can experience a passive reset (e.g., passive quenching), which can be implemented via a passive circuit such as a passive quenching circuit. In some other cases, the SPAD pixels can experience an active reset (e.g., active quenching), which can be implemented via an active quenching circuit (e.g., initiated via a digital output pulse to reduce bias voltage across an active quenching circuit). Thus, at any given time, there can be a number of non-activated pixels of the SPAD capable of capturing a light signal, another number of activated pixels that cannot detect another photon until reset, and another number of pixels being reset (e.g., within the reset time) unable to capture light signals. Thus, the photocount value of a given time for the SPAD 200 can be dependent on the number of pixels capable of capturing the distributed light signals at a given time. Further, in some cases the reset time can be pixel-specific or across pixels. For example, a specific reset time can be 10 ns, where a particular pixel is in a reset stage or more for the 10 ns (e.g., independent of other pixels). In other cases, a general reset time can be 10 ns, where each pixel that enters a reset stage or mode across the SPAD waits to reset simultaneously.

FIG. 3 depicts a detector 300 according to the present disclosure. The detector can include a SPAD 200, along with underlying electronics 305 configured to receive electronic signals corresponding to the captured light signals by the SPAD pixels. In some cases, the electronics 305 can include one or more ASICs configured to generate a signal indicative of a photocount value for a given time, based on a number of light signals captured by the SPAD 200 at the given time. In some cases, the electronics 305 can further send the photocount signal to other components of the flow cytometry system such as acquisition electronics 145 of FIG. 1. In some cases, the electronics 305 can also process the photocount signal, such as by adjusting photocount value, which will be discussed in more detail.

In some cases, the detector can include inputs for power 310, ground 325, clock 315, control 320, and an output 330 for the data. The Clock 315 can be a reference clock to synchronize all sampling across multiple detectors in the system. The Control 320 can be a bus (e.g., I2C) and can be used for setting control parameters, reading back status, disabling any pixels identified as being noisy, disabling pixels that might not be used by the optical system, or any other number of functions. Additional functions, such as selecting imaging mode where the grid of pixel values is encoded and returned could provide additional information.

The Output 330 can be the number of total detected photons during the sampling period and could be done as an LVDS output pair for high speed, low noise transmission. To simplify data transmission, it can be optimal to add a prefix to the data, such as a bit pattern of 0100. If the normal output data was set for a 12-bit value, appending the bit pattern of 0100 would give a 16-bit output value. The advantage of the extra bits is to force the data to have transitions so that an FPGA or other processing device can remain synchronized to the data stream even if it is sending all 0s or 1s and to give a very clear indicator on data alignment. Ground 325 can provide a reference from which voltages or current can be measured for the detector.

As used in a system, a detector can be a replacement for PMTS in instruments such as, but not limited to flow cytometers and laser scanning fluorescent microscopes. Optical detection can occur with fiber pick off after the collection objective (e.g., with one fiber per interrogation point), dichroic and optical filters to direct and select the desired light. In addition, focusing and flattening optics to distribute the light evenly onto the detector might be added.

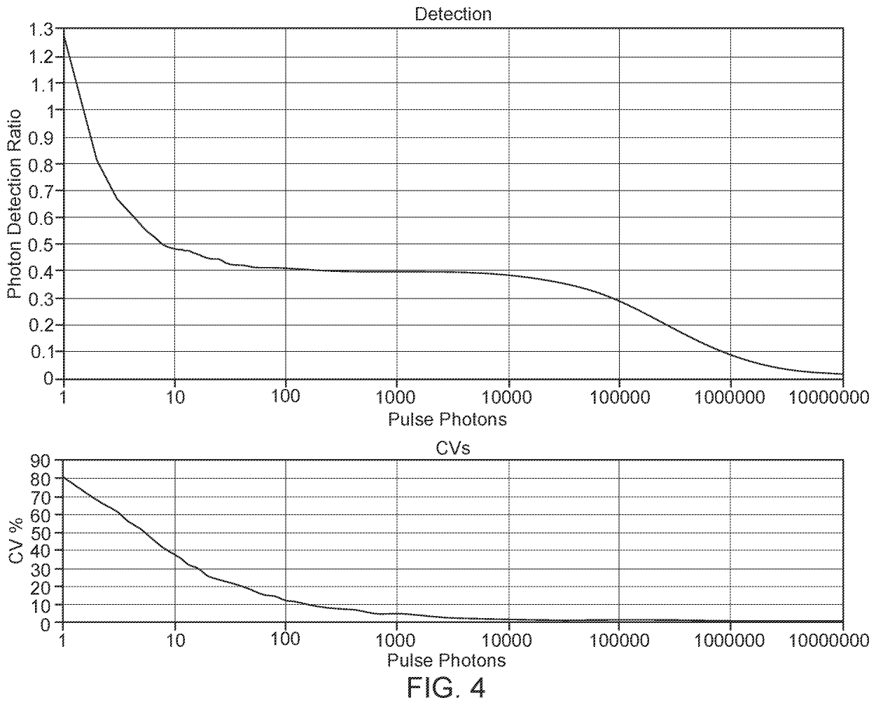

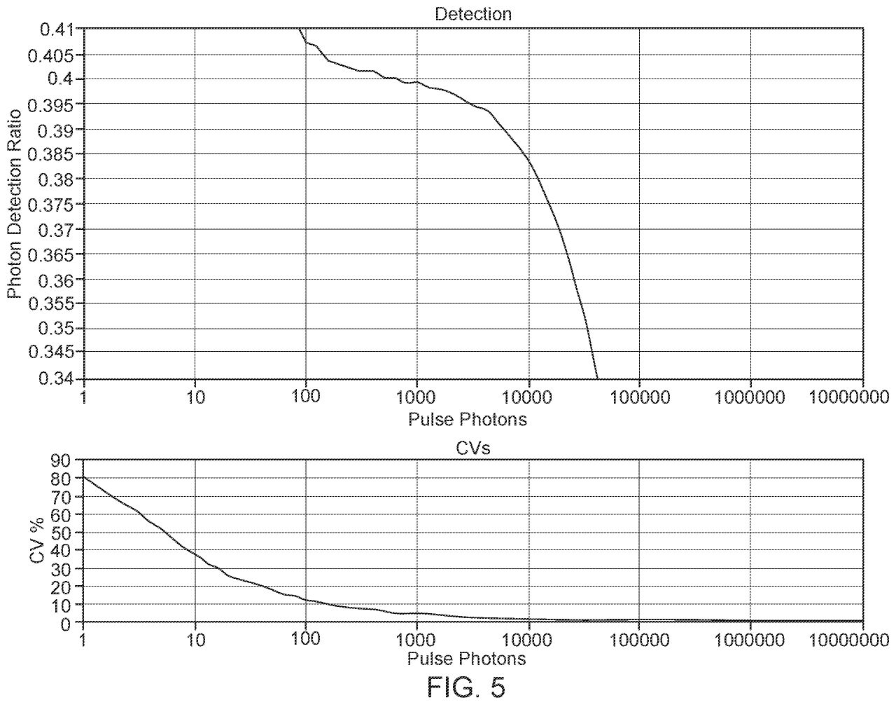

FIG. 4 depicts simulated detection counts of a SPAD for gaussian light pulses with increasing number of photons versus the detected number of photons. A system with perfect detection would be a flat line of 1.0 for detection ratio, meaning that for every incoming photon the system detected 1.0 photons. This also models in quantum efficiency, so for this system simulated at 40% quantum efficiency perfect detection would be a flat line at 0.4. FIG. 5 depicts a magnified view of the upper graph of FIG. 4, where the photon detection ratio axis is magnified. Here the dark noise can be seen increasing the ratio for very small numbers of photons, because a dark noise event activating a pixel is indistinguishable from an actual photon and at very low photon input levels the dark noise becomes apparent. Because noise has always been present in flow cytometers, and because very dim biological signals have a large distribution, this is acceptable. However, the primary issue is the loss of linearity. Zooming in to see a better view of the linearity shows it is approximately 1.5% off referred to total photon count, which is 3.75% referred to the detected photon count, at the 10,000 photon input.

The simulation graphs of FIGS. 4 and 5 are associated with simulated results for a SPAD chip setup having 4096 total pixels with the read out at 30 MHZ, which sets the sampling period to 33.333 ns. Each pixel can have an average of 100 counts/second of noise and a pixel reset time of 10 ns. The pixel reset time can apply to a pixel that was previously set and must be quenched, and quenching is performed at the beginning of the sampling period. During the reset time the respective pixel cannot detect a new photon.

This non-linearity is the same issue that limits dynamic range on the high end of MPPCs caused by pixel saturation. MPPCs can improve linearity by having a circuit that resets each pixel as quickly as possible. That does improve linearity to a degree, but not as much as would be desired. However, by doing this detection with photon counting that periodically resets the pixels, the SPAD can take advantage of the fact that as pixels detect photons the average detection efficiency decreases. That is, for example, that with 50% of pixels filled, the detection probability of another photon is now 50% of what it started as. The next photon detected at this point can represent a statistical 2 photons. A correction table of each detection level can be computed to create a look-up-table that corrects the detected number of photons into the expected number of photons that would have been incident to fill that many pixels.

The reset time of the pixels can further assist by decreasing the probability of detecting photons during periods of high flux. This can also be corrected for, by taking the number of pixels known to be reset during a given time and using the ratio of the reset time versus the sampling period.

Pulling these correction factors together can correct the linearity to improve dynamic range by about two decades.

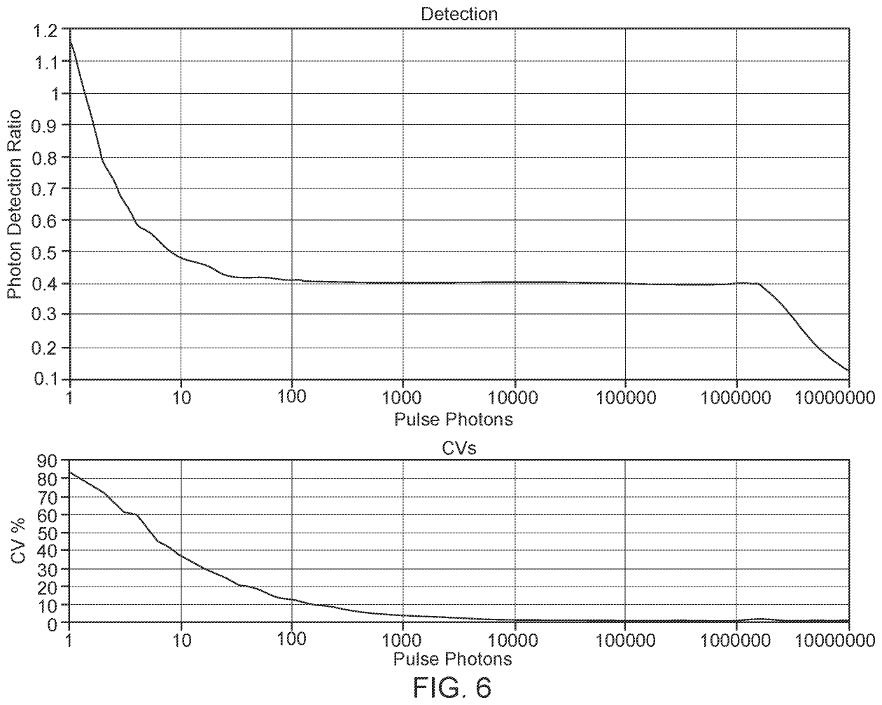

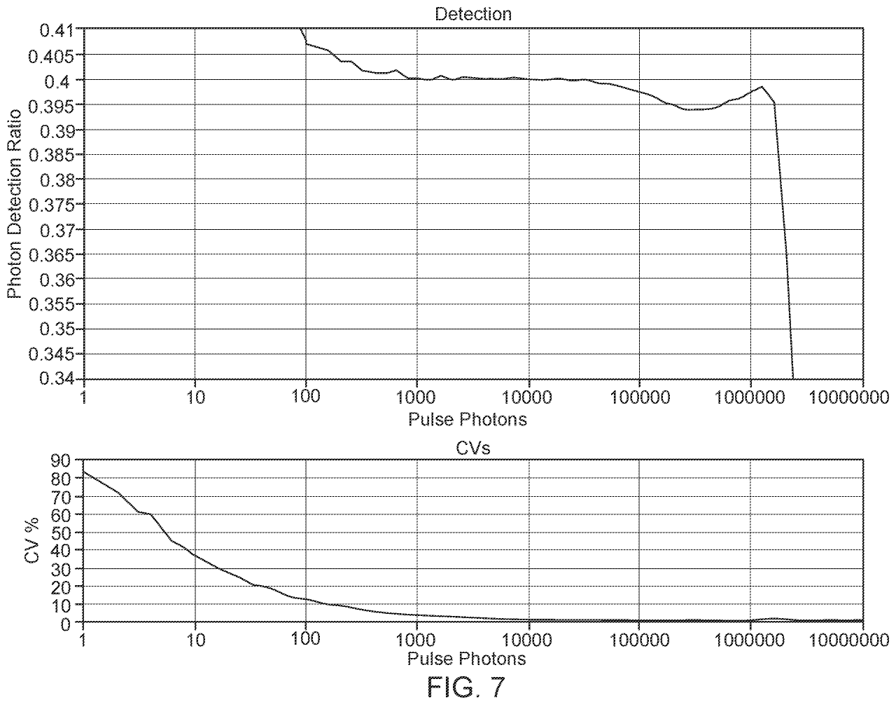

FIG. 6 depicts a graph of simulated detection counts for a SPAD, where the detection counts are adjusted for based on the number of activated pixels at the time of detection (e.g., with linearity correction enabled). Similar to FIG. 5, FIG. 7 depicts a magnified view of the upper graph of FIG. 6, where the photon detection ratio axis is magnified. Here it can be seen that the linearity is greatly improved and is now linear to over 1,000,000 incident photons. The simulator is configured to randomly distribute photons across the entire surface of the chip, however, this random distribution is not required, and other types of distribution of photons can be implemented. In these other cases, the linearity corrections can be adjusted based on the type of distribution provided.

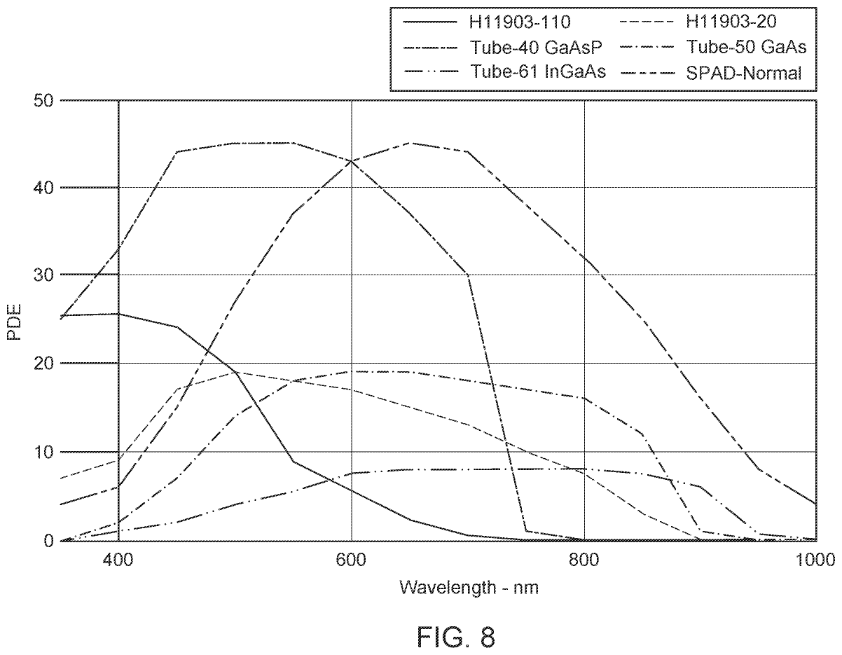

FIG. 8 depicts various detector photon detection efficiency (PDE) for different wavelengths. Here the typical SPAD performance is in blue, while the other colors represent PMTs. The light and dark green are the standard tube types. The orange and purple curves represent improved PMTs.

The SPAD PDE shows extremely strong performance from 500 nm on and greatly outperforms the PMTs in the red and near-IR range.

### Computation for Correction Factor

For a 4096 pixel array, input values for a detection period can range from 0 to 4096, where the value represents the number of pixels that were activated. The correction factor can be computed for each input value (PixeIsCounted) to get the CorrectedValue which is the number of photons that would be expected to produce the values as seen by counting activated pixels.

$$CorrectedValue = {\sum }_{i = 0}^{PixelsCounted - 1} 1 / ( \frac{NumPixels - i}{NumPixels} )$$

Where: PixeIsCounted is the current pixel value being computed, from the first time (1), then second in time (2) etc. NumPixels is the total number of pixels. For an example with 4096 pixels, this gives starting results of:

| PixelsCounted | Corrected Value |
|---|---|
| 1 | 1.00000 |
| 2 | 2.00024 |
| 3 | 3.00073 |
| 4 | 4.00147 |
| . . . | |
| 4093 | 28925.01223 |
| 4094 | 30290.34556 |
| 4095 | 32338.34556 |
| 4096 | 36434.34556 |

In some cases, these correction factors can be computed ahead of time and stored in a Look Up Table (LUT) for instantaneous correction.

### Computation of Reset Correction Factor for Active Reset Systems

The Reset Correction Factor can be applied once based on the number of pixels that were activated on the prior cycle, and the modifier can be applied to the Corrected Value. It is computed as the ratio of previously activated pixels to total pixels and scaled against the ratio of reset time to period time.

$$FinalCorrectedValue = \frac{CorrectedValue}{1 - ( \frac{PreviousPixelCount}{TotalPixels} \times \frac{PixelResetTime}{DetectionPeriod} )}$$

Where: PreviousPixelCount is the number of pixels activated on the previous period; TotalPixels is the total number of detector pixels; PixelResetTime is the time it takes a pixel to flip from activated back to enabled when reset; and DetectionPeriod is the time period of one detection cycle (1/Frequency).

For example, 1000 pixels can be activated on the previous clock for a 4096 pixel system, with a 10 ns Pixel Reset Time and a 33.33333 ns Detection Period, a Corrected Value of 1146.31 can be calculated and can get adjusted to be 1236.90 photons.

### Computation of Reset Correction Factor for Passive Reset Systems

The previous has mostly discussed an active reset of pixels, or possible also called synchronous quenching where the pixel reset is done at the beginning of a clock cycle. However, currently the standard pixel from ST Micro has passive quench, where the pixel resets as quickly as possible after being set without any relationship to the clock. This is currently about 10 ns after the pixel is set by a photon. With this functionality a pixel can become activated more than once during a clock period

For a passive reset system, the Corrected Value only requires a single computation and is based on how many photons were counted as compared to the total time availability of pixels when not in reset. Because a pixel can be reset and count more than one photon during a clock period, the correction table must be computed for more values. To cover the full range of possibilities, the Number Of Iterations can be calculated as:

$$NumberOfIterations = TotalPixels \times \frac{DetectionPeriod}{PixelResetTime}$$

Where TotalPixels is the total number of detector pixels; PixelResetTime is the time it takes a pixel to flip back to active; and DetectionPeriod is the time period of one detection cycle (1/Frequency).

The computation can then be done for each iteration to create a table when the index into the table is the number of photons detected, and the output is the number of photons expected to have been present:

$$CorrectedValue = \frac{PhotonsCounted}{( \frac{\begin{matrix}( DetectionPeriod \times TotalPixels ) - \\ ( PixelResetTime \times PhotonsCounted )\end{matrix}}{DetectionPeriod \times TotalPixels} )}$$

Where PhotonsCounted is the number of pixel activations counted on the previous period; TotalPixels is the total number of detector pixels; PixelResetTime is the time it takes a pixel to flip back to active; and DetectionPeriod is the time period of one detection cycle (1/Frequency).

For example, if 1000 photons were counted on the previous clock for a 4096 pixel system, with a 10 ns Pixel Reset Time and a 40 ns Detection Period, a Corrected Value of 1065.00260 would be computed. This could also be computed ahead of time, likely turned into a multiplicative correction factor to avoid division.

In some cases, a rectangular array can be formed that would allow light to be split across the detector, such that one dimension of the detector has multiple pixels to improve detection as described and a second dimension to detect different wavelengths of light. This can require a prism, grating, or other splitting technique to spread the light by wavelength.

Another implementation for handling of light can be to enlarge the detector area to cover the multiple interrogation sites for the flow cytometer. Since the cells move in a linear motion thru the various laser interrogation spots in the stream, a lens can be used to simultaneously focus the emitted light from all of the interrogation spots onto a detector surface, such that the separate interrogation spots are spatially separated and distributed onto unique areas of the detector. The optical system design can include using dichroics and filters to split the light for each laser path simultaneously after the lens (and in free space) to divide the light into different paths based on the wavelength of light and still have each unique path come to a focus for the multiple interrogation sites at the detector surface. As this applies to the detector, an array detector can then be used to detect light from multiple lasers in different parts of the detector. Of course, this could also be accomplished by placing multiple singular SPAD detectors into a package with the correct spacing between each device to collect the light from the multiple interrogation sites. The flexibility of this invention, is an improvement over that implementation. For example, a 1 mm×10 mm detector can be composed of 32×320 pixels, or perhaps 64×640 pixels. The light from different laser collection spots can be incident at different portions of the detector array. Thus, the detector array can be configured for each laser to select which pixels applied to that laser. For example, a spectral cell sorter may have 7 laser collection spots, so the detector can be configured to treat 7 different zones of the detector separately. This can be done via configuration, or the detector can be designed or pre-configured to treat different groups of pixels as individual detectors. For the example of the 1×10 mm array, the array can be configured as 10 different 1×1 mm detectors. Or, to match the spectral cell sorter, the detector can be configured as 7 different 1×1 detector zones with space between that is not enabled.

Such a detector can share the chip inputs but be setup to have multiple outputs to keep the bandwidth of each output reasonable. For example, a chip setup for a spectral cell sorter can include 7 different LVDS outputs, one for each detector. Or, to save on wiring and cabling, each output can handle data for one or more output detectors in an interleaved fashion. At 30 MHz, if outputting 16-bit data as previously described, each channel can include a rate of 480 Mbps. Two channels can be interleaved on one output to reduce the data links by half, and then each output would be at 960 Mbps. Standard LVDS at 960 Mbps can be received on LVDS inputs of an FPGA. For a spectral cell sorter, this can enable existing electronics with 60 LVDS inputs to process data for double the number of channels currently capable.

To indicate which data is being output, prefix bits in the data stream can be changed such that the first channel data is prefix 0100 and the second channel data is 0101.

This can provide for a system that is more compact and efficient, with reduced cost of goods, and a reduced number of total detectors.

### Optical Configuration

According to the present disclosure, the flow cytometer can include an optical configuration allowing for a single detector output or multiple detector areas to receive a similar fluorescence channel across multiple laser interrogation points and to output multiple detector signals from the same array. Because the detector is an array that is placed at the focal point of a lens, the optical system can use the same optical filters across all of the interrogation points and allow the light across multiple (physically separated) positions to be processed as independent signals on the detector array that are dedicated to each interrogation point. The total number of processed signals can be equal to (or less than) the total number of lasers. Since there is an unique imaging area and data processing circuitry for each interrogation point, the data processing will not suffer from the coincidence problem and can be tuned to the maximum benefit of the channel.

Instead of using the optical system of the flow cytometer to create completely separated optical detection banks, optical configurations described herein can shrink the size of the detection architecture that comes from the multiple integration areas so that they share optical filters in the free space architecture for as long as possible which can reduce the cost of lenses and filters. It also creates a smaller footprint in the instrument.

The configuration also has a benefit for the detection of the side scatter signals for the lasers. Because the detection of the fluorescence signals across multiple interrogation points can require a high-quality collection lens that covers a broad wavelength range with high resolution, the configuration provides excellent collection of the scatter channels. Since the scatter channels are orders of magnitude more intense than the fluorescence signals, there is an advantage to adding a custom optical filter (scatter pickoff) to remove the wavelength bands around each of the lasers early in the optical system, such that the fluorescence light travels to the fluorescence filter area without as much of the laser light. The scatter pickoff optical element can include the benefit of sending all the laser scatter from all of the interrogation points to a separate detector array (similar to the fluorescence detector arrays shown later). But in this case, the scatter signals are spatially separated but have the wavelength equal to the laser at the corresponding interrogation point. Depending on the quality of scatter signal needed, the different wavelengths may need to be spatially filtered or put through band pass filters before detection. Fortunately, this architecture gives access to the high-quality image spots in free space to be able to do further conditioning of 1, 2 or all of the scatter signals before detection.

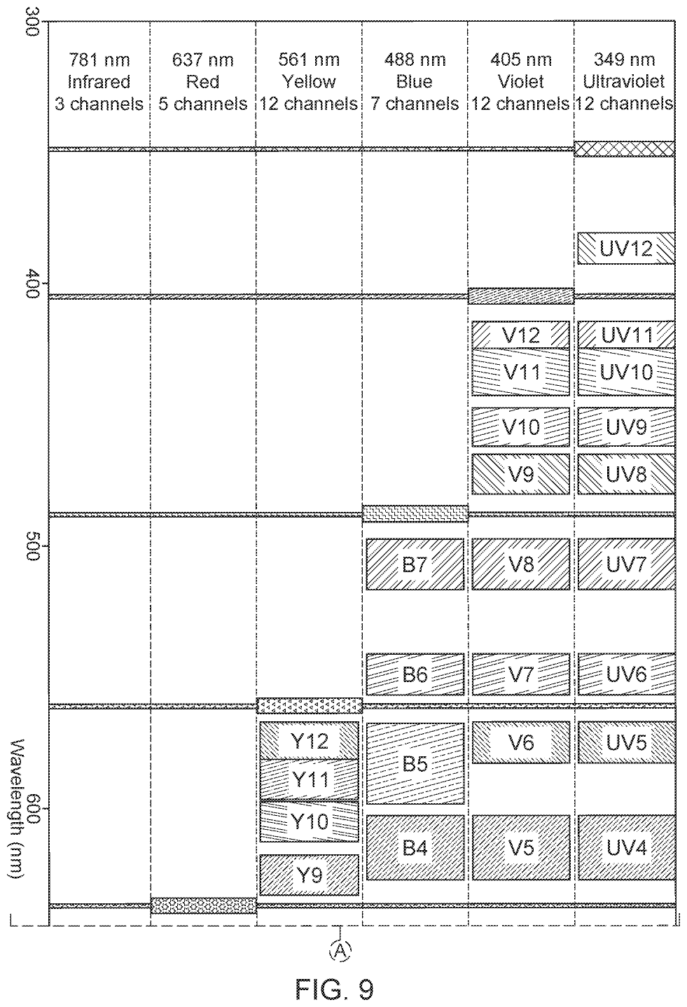

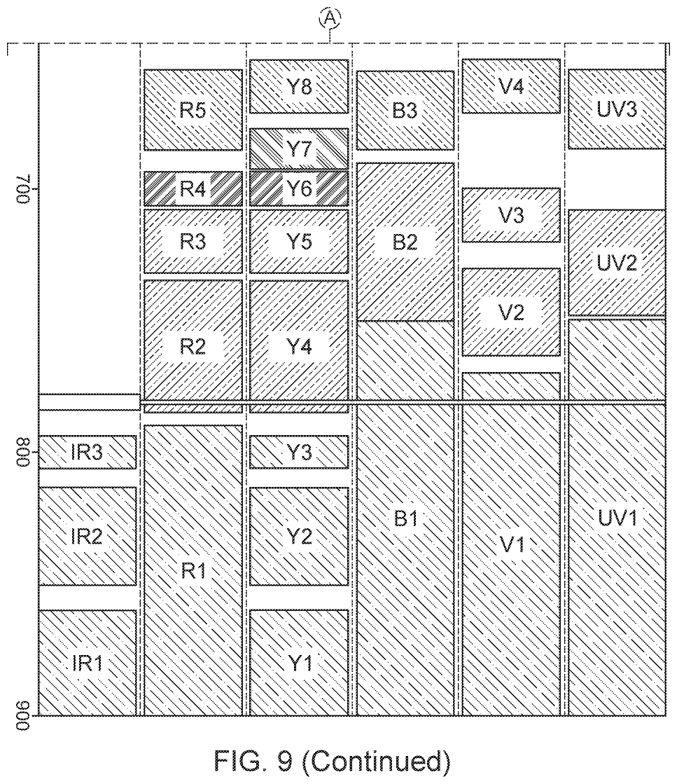

For example, the optical configuration for a flow cytometry system can create a common set of fluorescence channels across multiple lasers. In addition, the preferred implementation uses the actual lasers of the system to create common breakpoints in the light spectrum across the multiple interrogation points. In FIG. 9, a filter configuration for a flow cytometer is shown.

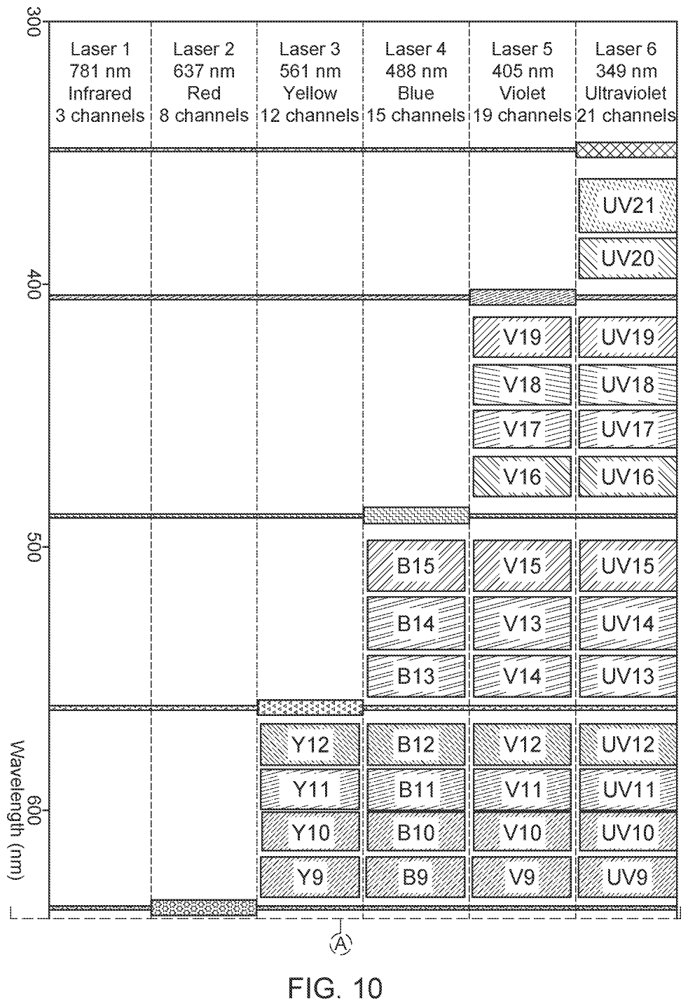

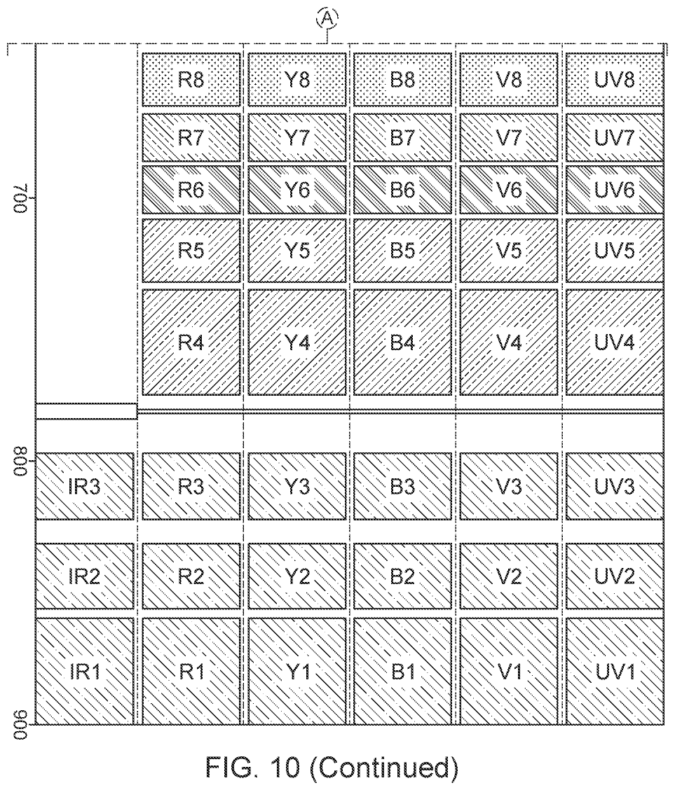

For instance, an exemplary configuration for a flow cytometer may include a 6 laser, 51 channel system where optical filters on each are similar for fluorescence from different lasers. With the optical configuration described herein, it is advantageous to use the same filters across as many lasers as possible. FIG. 10 shows how the filter sets could be expanded to maximize the duplication of filters across the lasers.

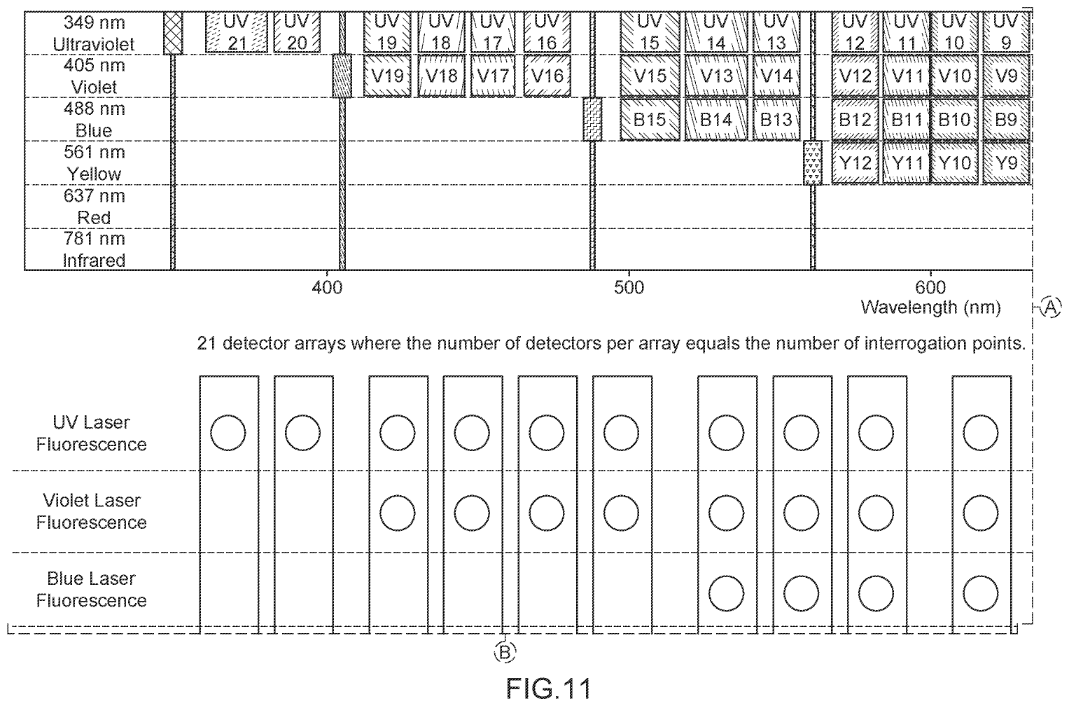

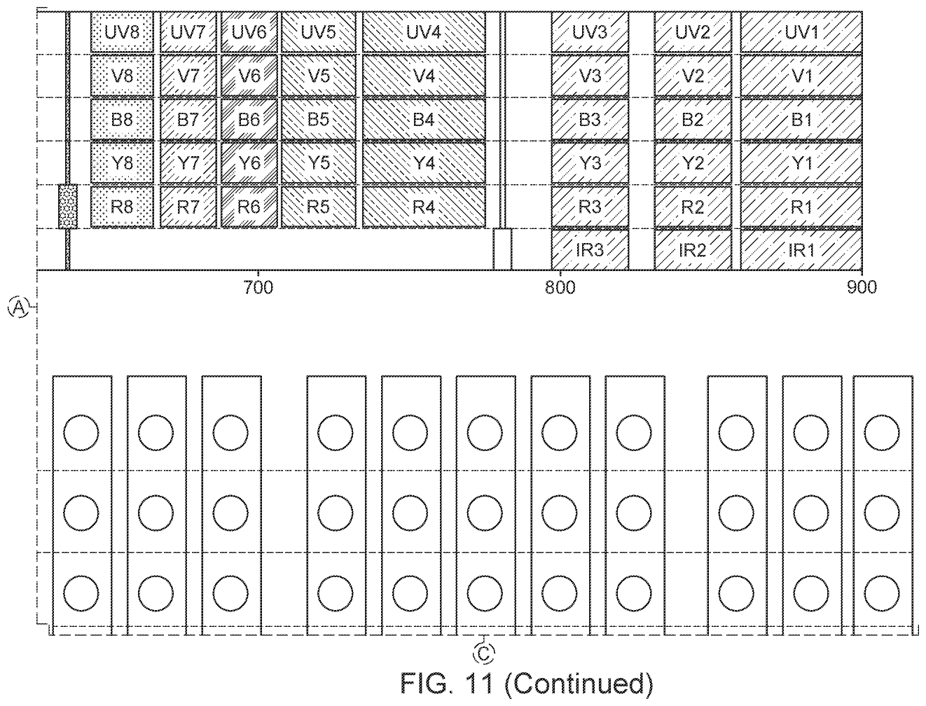

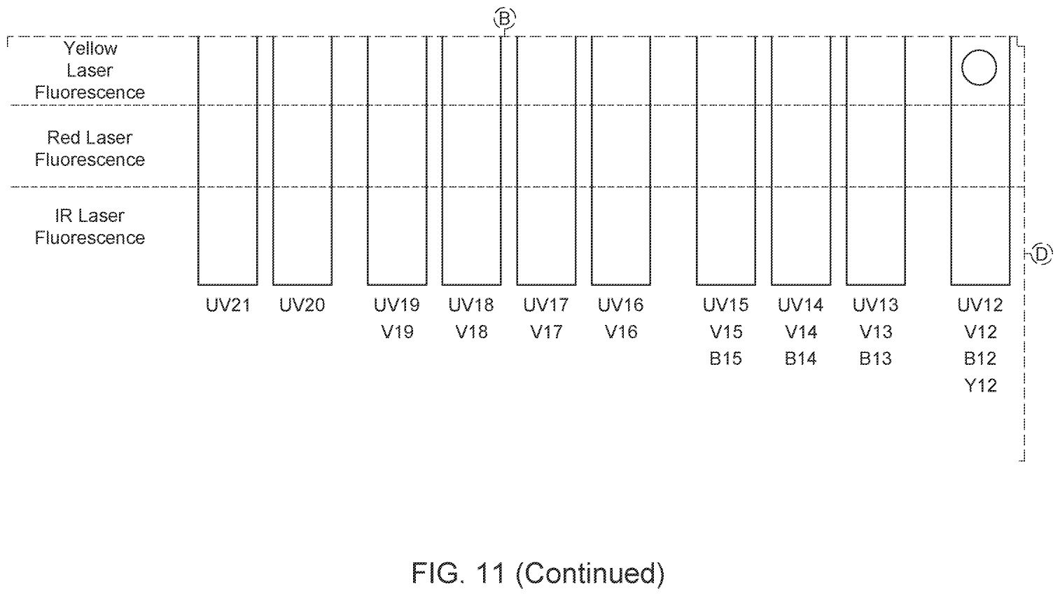

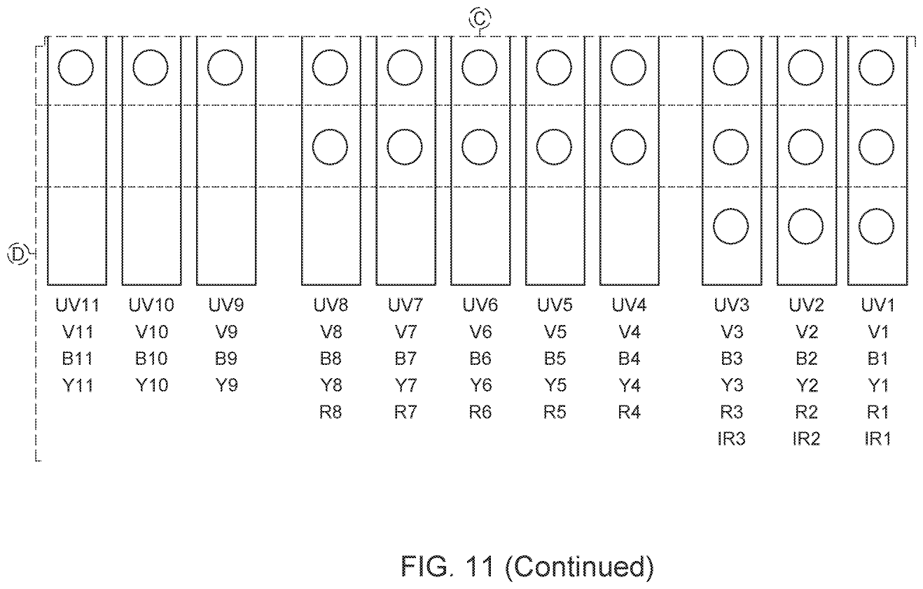

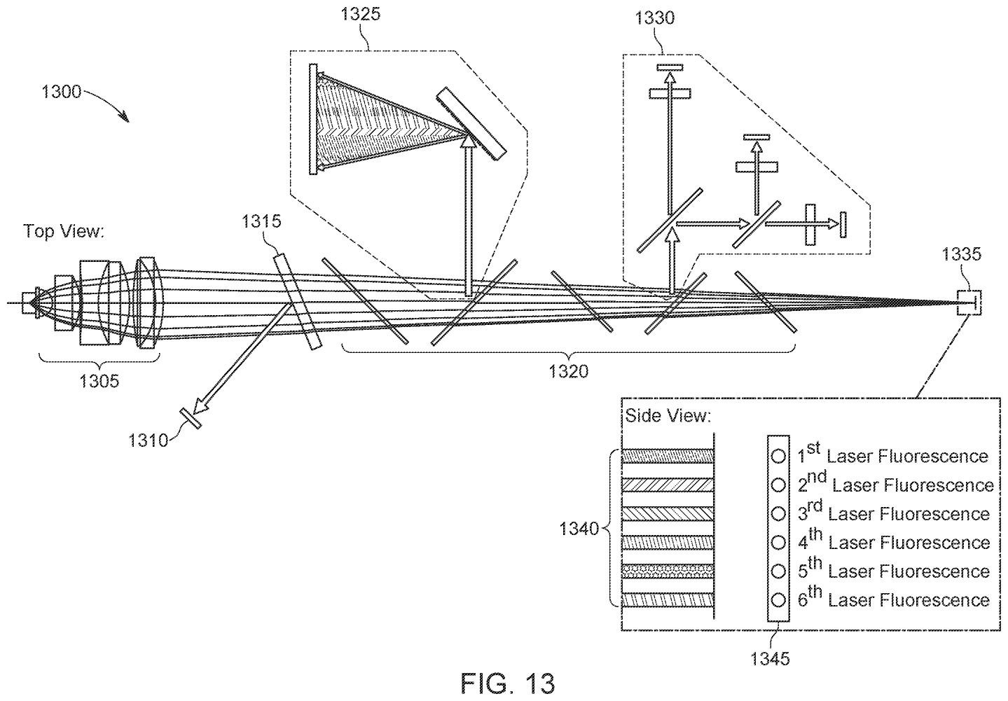

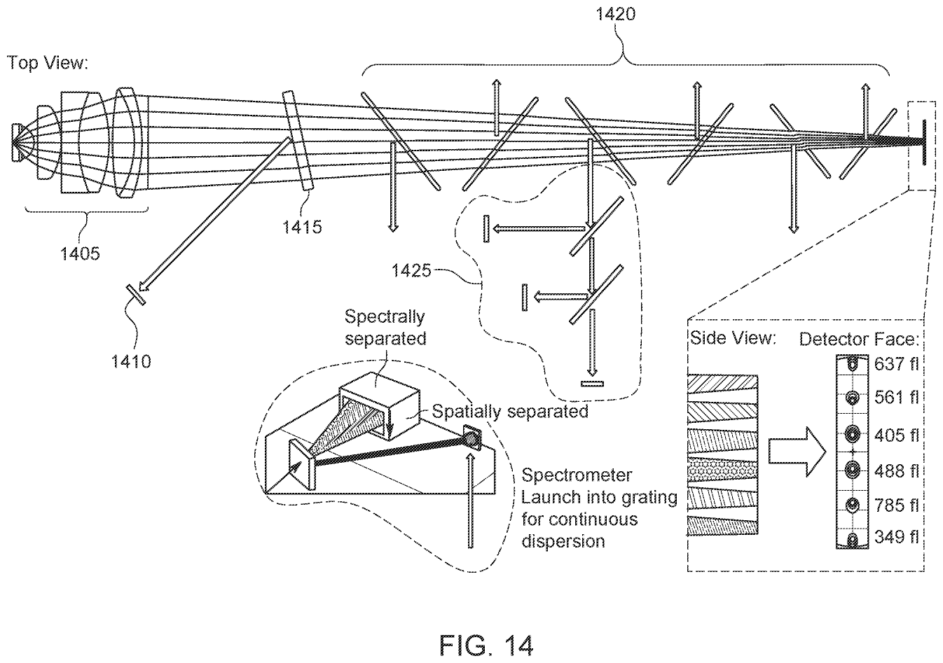

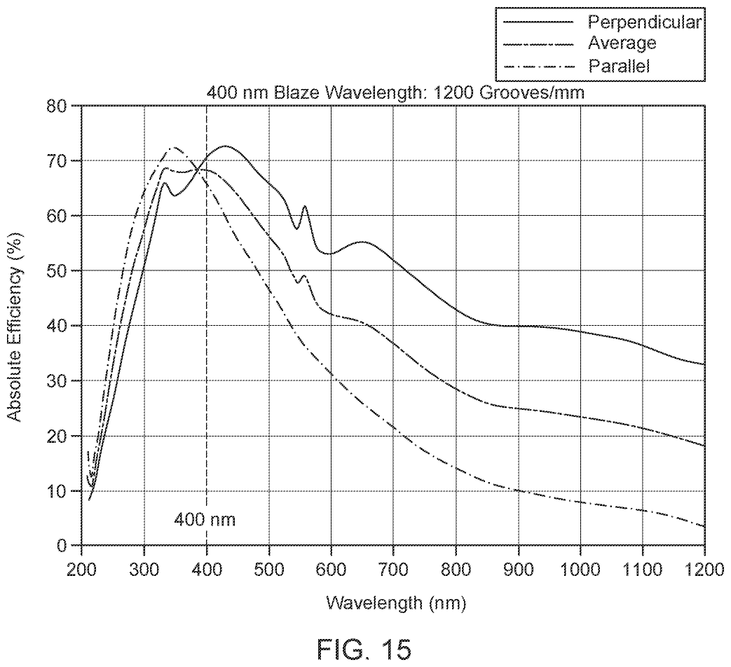

For example, the total number of fluorescence channels can be increased from 51 to 78, but the addition of the detector arrays across the multiple interrogation points means that the total number of bandpass filters can be reduced from 51 to 21. FIG. 11 shows how the detector arrays can be used to efficiently collect the light. For example, the total number of fluorescence channels shown in FIGS. 11A-D are 78, and the total number of detector arrays are 21. The optical configurations described herein, such as those shown in FIGS. 13 and 14, can thus provide for granular separation of light into respective wavelengths (or wavelength ranges). The light can originate from multiple interrogation points (for example, 6 interrogation points), while limiting the optical hardware implemented in the optical pathway (for example, by sharing common optical components for the light emitted from the multiple interrogation for at least a portion of the optical pathway). In some cases, SPAD detectors or SPAD detector arrays may be used in the systems described herein. However, other detector or detector arrays may be implemented in lieu of, or in combination with, SPAD detectors or SPAD detector arrays. For example, some other detectors that may be implemented in the described systems may include Avalanche Photo Diodes (APDs), Multi Pixel Photon Counters (MPPCs), Photomultiplier Tubes (PMTs), and the like.

The optical configuration can further reduce the number of dichroic filters by using the same filters across all the lasers. The detection pathways can be collectively managed and the image quality of the optical system can be sufficiently high to create the multiple paths to the detector arrays across all of the interrogation points.

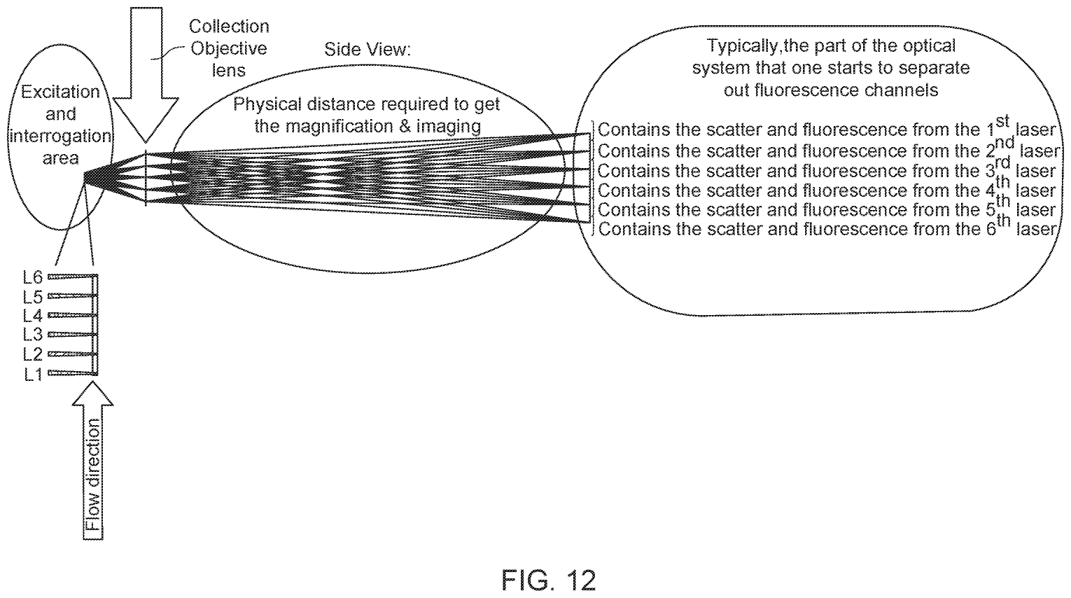

FIG. 12 shows how a single collection objective lens is typically designed to separate the individual interrogation points with a high magnification factor at an image plane. At the image plane, the scatter and fluorescence data from each interrogation point is usually separated from the others via filters, mirrors or prisms. In a typical optical pathway, a distance is required from a collective objective lens to result in proper magnification and imaging of emissions. Then, additional optical hardware is provided, once the distance is met, to separate out fluorescence channels. For example, this second section of the optical pathway can, in cases where 6 interrogation points are involved, separate out the scatter and fluorescence from each respective laser.

The optical configuration described herein can utilize the section of the optical system that is used for the magnification and imaging to also be utilized for the purpose of the fluorescence detection system across all the interrogation points. FIG. 13 shows a system model 1300 where the dichroic filters 1320 are set to all be short pass filters and designed at the same central wavelengths as the lasers in the system to create discrete “blocks” of light that do not span any lasers, but rather exist between the defined laser wavelengths. This optical design allows for each “block” of fluorescence to be directed into a separate physical path. The optical spectrum of a “block” is fairly narrow in bandwidth and still contains all of the data from all of the interrogation sites. The optical system design must decide how to further condition this “block” of light to filter to 1 or multiple bands of light before coming to a focus onto the detector array 1335 and circuitry that has been discussed previously.

The system model 1300 may also include objective lens subsystem 1305, which may include high quality objective lens(es). The objective lens(es) can be customizable with different lens modules for different systems (e.g., flow analyzer, flow sorter, spectral confocal microscopes, and the like). The light may pass through the objective lens subsystem 1305 and interact with a scatter filter 1315 (e.g., a multi-notch scatter filter). Some portions of the light may be directed towards a light detector, such as a side scattered light detector 1310, which may receive scattered light originating from some or all of the excitation lasers in use for generating the light in the system 1300. Other portions of the light, when interacting with the scatter filter 1315, may pass to the dichroic filters 1320 as discussed above. Some of the light interacting with the dichroic filters 1320 may be directed to a spectrometer module 1325, which can launch light into diffractions gratings for continuous dispersion across a detector. Some of the light interacting with the dichroic filters 1320 may be directed to a divide and conquer module 1330, which may launch light into a series of dichroic mirrors and bandpass filters for detection of wavelength bands at each detector. Some of the light interacting with the dichroic filters may be directed to detector 1335 having a detector array face 1345. For example, the detector array face is showing, from top to bottom, a first portion of the detector array configured to collect fluorescence from a first laser, a second portion of the detector array configured to collect fluorescence from a second laser, a third portion of the detector array configured to collect fluorescence from a third laser, a fourth portion of the detector array configured to collect fluorescence from a fourth laser, a fifth portion of the detector array configured to collect fluorescence from a fifth laser, and a sixth portion of the detector array configured to collect fluorescence from a sixth laser, The light reaching the detector 1335 may be oriented as interrogations points 1340 that are imaged by the objective lens to common focal plane at the detector 1335.

The optical configuration can also be modular. It is common in flow cytometry for instruments to have multiple configurations with fewer or more excitation lasers. Subtracting a laser from this configuration entails removing its corresponding dichroic pickoff mirror (and any filters after). The opposite is true for adding laser: it is possible to add another dichroic mirror for the additional laser's fluorescence, or it is possible to keep the current architecture. In both situations, adding a spatially separate laser source necessitates an additional detector on the detector array. Adding more lasers may also necessitate a different coating on the scatter pickoff mirror or the addition of a bandpass to block the new laser's scatter from reaching fluorescence detectors.

As discussed in FIG. 13, the light that is taken out of the main imaging section can be further processed to separate the fluorescence into the final channels of light, but due to the imaging properties, the light at each of the desired colors can continue to focus along the divert path and can still come to an image plane at the same total distance away from the lens. In addition, the separation of the light in the various sections can be done with dichroics and bandpass filters or can use other dispersive technologies such as prisms and diffraction gratings. Each section of light can be handled in a unique way and can even be user changeable. FIG. 14 shows more of a generic design and possible technologies that are still compatible with the architecture proposed. For example, FIG. 14 shows an objective lens subsystem 1405, which may be an example of 1305 of FIG. 13; side scatter detector 1410 which may be an example of side scatter detector 1310 of FIG. 13; scatter filter 1415, which may be an example of scatter filter 1315 of FIG. 13; dichroic filters 1420, which may be example of dichroic filters 1320 of FIG. 13; and divide and conquer module 1425, which may be an example of divide and conquer module 1330 of FIG. 13. Some of the light interacting with the dichroic filters 1420 may be directed to a spectrometer module, which can launch light into diffraction gratings for continuous dispersion across a detector. For example, the light can be spectrally separated, spatially separated, or both.

In some cases, the optical configuration can facilitate alignment of the flow cytometer. For example, a SPAD array can be an end point of the main optical pathway (e.g., a 32×320 pixel array). The flow cytometer can be configured to operate in a mode that sends back an “image” of the pixels instead of summing them. In some cases, the SPAD array can be instructed to operate in this particular mode, for example, via a I2C or other communication bus, to operate in this mode for a sampling period. The SPAD array can then send data that represents non-activated pixels (e.g., a 0) and for activated pixels (e.g., a 1), which can then be read to form a black and white “image” of photon density.

In some cases, this alignment process or mode can include viewing the image described above while adjusting optical elements to affect the focusing or positioning of the light to make sure it is optimized on the detector surface. Additionally, the alignment process can facilitate determining which regions of the SPAD array can be assigned as enabled for each detection area.

### EXEMPLARY EMBODIMENTS

The following embodiments are exemplary only and do not serve to limit the scope of the present disclosure of the appended claims. It should be understood that any part of any one or more Embodiments can be combined with any part of any other one or more Embodiments.

### Embodiment 1

A computer-implemented method, comprising: receiving one or more light signals at a point in time, wherein each light signal is captured by a respective pixel of a single-photon avalanche diode (SPAD) array; determining a number of activated pixels for the SPAD array during the point in time; and based on the number of activated pixels of the SPAD detector for the point in time, adjusting a count of light signals captured by the SPAD detector for the point in time.

### Embodiment 2

The computer-implemented method of Embodiment 1, further comprising: causing the adjusted count to be stored in memory.

### Embodiment 3

The computer-implemented method of any of Embodiments 1 through 2, wherein the SPAD array comprises a SPAD detector.

### Embodiment 4

The computer-implemented method of any of Embodiments 1 through 3, wherein the SPAD array comprises a 32×32 array of pixels.

### Embodiment 5

The computer-implemented method of any of Embodiments 1 through 4, comprising receiving a plurality of light signals, wherein each light signal is captured by a respective pixel of a different one of a plurality of single-photon avalanche diode (SPAD) array.

### Embodiment 6

The computer-implemented method of any of Embodiments 1 through 5, wherein the reset time comprises 10 ns.

### Embodiment 7

The computer-implemented method of any of Embodiments 1 through 6, wherein the reset time is unique to each respective pixel.

### Embodiment 8

The computer-implemented method of any of Embodiments 1 through 7, further comprising: determining a correction factor for the received one or more light signals based on the number of activated pixels for the point in time, and adjusting the count of light signals based on the correction factor.

### Embodiment 9

The computer-implemented method of any of Embodiments 1 through 8, wherein determining the correction factor comprises retrieving the correction factor from a lookup table.

### Embodiment 10

The computer-implemented method of any of Embodiments 1 through 9, wherein the correction factor is determined according to:

$$CorrectedValue = {\sum }_{i = 0}^{PixelsCounted - 1} 1 / ( \frac{NumPixels - i}{NumPixels} ) ,$$

wherein CorrectedValue comprises the correction factor, PixeIsCounted comprises the number of activated pixels, and NumPixels comprises a total number of pixels for he SPAD array.

### Embodiment 11

The computer-implemented method of any of Embodiments 1 through 10, wherein the count of lights signals is adjusted according to:

$$FinalCorrectedValue = \frac{CorrectedValue}{1 - ( \frac{PreviousPixelCount}{TotalPixels} \times \frac{PixelResetTime}{DetectionPeriod} )} ,$$

wherein CorrectedValue comprises the correction factor, TotalPixels comprises a total number of pixels of the SPAD array, PreviousPixelCount comprises a number of previous activated pixels of the SPAD array for a previous time period, PixelReset Time comprises a reset time for a respective pixel of the SPAD array, and Detection Period comprises a detection cycle for a respective pixel of the SPAD array.

### Embodiment 12

The computer-implemented method of any of Embodiments 1 through 12, wherein a light signal comprises a photon.

### Embodiment 13

The computer-implemented method of claim 1, further comprising relating the count of light signals to a property of a particle from which the light signals were emitted, the particle being a cell.

### Embodiment 14

A flow cytometry system, comprising: a flow cytometer configured to illuminate a particle located at an interrogation site; and a single-photon avalanche diode (SPAD) detector configured to capture emissions resulting from the particle illuminated at the interrogation site.

### Embodiment 15

The flow cytometry system of Embodiment 14, further comprising a controller configured to perform the Embodiments of any of claims 1 through 13.

### Embodiment 16

A non-transitory computer-readable medium comprising: a processor; memory; and

computer-executable instructions stored in the memory that, when executed, cause the processor to perform the computer-implemented methods of any of Embodiments 1 through 13.

### Embodiment 17

A flow cytometry system, comprising: a plurality of lasers, wherein each laser of the plurality of lasers is configured to illuminate a particle at a corresponding interrogation site; a first optical filter (i) positioned within a main optical pathway of illuminated emissions from the particle after excitation by the illumination originating from the plurality of lasers and (ii) configured to receive illuminated emissions from at least one laser of the plurality of lasers and redirect a first portion of the received illuminated emissions along a first auxiliary optical pathway; and at least one single-photon avalanche diode (SPAD) array positioned and configured to receive illuminated emissions of the first auxiliary optical pathway.

### Embodiment 18

The flow cytometry system of Embodiment 17, wherein the first portion of the illuminated emissions is within a spectrum of wavelengths, wherein the at least one SPAD array comprises at least one region configured to receive a portion of the spectrum of wavelengths.

### Embodiment 19

The flow cytometry system of any of Embodiments 17 through 18, wherein a portion of the spectrum of wavelengths comprise a fluorescence channel.

### Embodiment 20

The flow cytometry system of any of Embodiments 17-19, wherein the at least one region comprises a pixel of the at least one SPAD array.

### Embodiment 21

The flow cytometry system of any of Embodiments 17 through 20, further comprising an optical detector positioned at an end of the main optical pathway and configured to collect illuminated emissions from the main optical pathway.

### Embodiment 22

The flow cytometry system of Embodiment 21, wherein the optical detector is configured to detect alignment of components of the main optical pathway.

### Embodiment 23

The flow cytometry system of any of Embodiments 17 through 22, further comprising a second optical filter (i) positioned along the auxiliary optical pathway and (ii) configured to redirect a second portion of the illuminated emissions from the plurality of lasers along a second auxiliary optical pathway.

### Embodiment 24

The flow cytometry system of Embodiment 23, further comprising a SPAD array positioned along the second auxiliary optical pathway and configured to receive illuminated emissions of the second auxiliary pathway.

### Embodiment 25

The flow cytometry system of claim 23, wherein the first auxiliary optical pathway and the second auxiliary optical pathway are received by the at least one SPAD array Embodiment 26

The flow cytometry system of any of Embodiments 17 through 25, wherein the optical filter comprises a dichroic mirror.

### Embodiment 27

The flow cytometry system of Embodiment 26, wherein the dichroic mirror comprises a 45 degree dichroic mirror.

### Embodiment 28

The flow cytometry system of any of Embodiments 17 through 26, further comprising a scatter filter positioned along the main optical pathway and between the plurality of lasers and the at least one optical filter, wherein the scatter filter is configured to redirect side scatter signals of the illuminated emissions away from the main optical pathway.

### Embodiment 29

The flow cytometry system of any of Embodiments 17 through 28, wherein each of the plurality of lasers is configured to emit light at a different wavelength compared to the other lasers.

### Embodiment 30

The flow cytometry system of any of Embodiments 17 through 29, further comprising an objective lens configured to receive the illuminated emissions from each of the plurality of lasers and direct the illuminated emissions to the main optical pathway.

### Embodiment 31

The flow cytometry system of any of Embodiments 17 through 30, further comprising a controller configured to perform the computer-implemented methods of any of claims 1 through 13.

What is claimed:

1. A method, comprising:
receiving one or more light signals at a point in time, wherein each light signal is captured by a respective pixel of at least one single-photon avalanche diode (SPAD) array,
wherein a pixel is activated for a reset time after capturing a light signal;
determining a number of activated pixels of the at least one SPAD array during the point in time; and
based on the number of activated pixels of the at least one SPAD array for the point in time, adjusting a count of light signals captured by the at least one SPAD array for the point in time;
optionally relating the count of light signals to a property of a particle from which the light signals were emitted, the particle optionally being a cell.

2. The method of claim 1, further comprising:
storing the adjusted count in memory.

3. The method of claim 1, wherein the at least one SPAD array is comprised in at least one SPAD detector.

4. The method of claim 1, wherein the SPAD array comprises a 32×32 array of pixels.

5. The method of claim 1, comprising receiving a plurality of light signals, wherein each light signal is captured by a respective pixel of a different one of a plurality of single-photon avalanche diode (SPAD) array.

6. The method of claim 1, wherein the reset time is about 10 ns.

7. The method of claim 1, wherein the reset time is unique to each respective pixel.

8. The method of claim 1, further comprising:
determining a correction factor for the received one or more light signals based on the number of activated pixels for the point in time; and
adjusting the count of light signals based on the correction factor, wherein the count of light signals is defined as FinalCorrectedValue in the following equation:
$$FinalCorrectedValue = \frac{CorrectedValue}{1 - ( \frac{PreviousPixelCount}{TotalPixels} \times \frac{PixelResetTime}{DetectionPeriod} )} ,$$
wherein CorrectedValue comprises the correction factor, TotalPixels comprises a total number of pixels of the SPAD array, PreviousPixelCount comprises a number of previously activated pixels of the SPAD array at a previous time period, PixelResetTime comprises a reset time for a pixel of the SPAD array, and Detection Period comprises a detection cycle for a respective pixel of the SPAD array.

9. The method of claim 8, wherein the correction factor is determined according to:
$$CorrectedValue = \frac{PhotonsCounted}{( \frac{\begin{matrix}( DetectionPeriod \times TotalPixels ) - \\ ( PixelResetTime \times PhotonsCounted )\end{matrix}}{DetectionPeriod \times TotalPixels} )} ,$$
wherein CorrectedValue comprises the correction factor, PhotonsCounted comprises a number of pixels activated on a previous detection cycle, PixelResetTime comprises a time period for resetting a pixel to an active state; Detection Period comprises a time period of a detection cycle; and TotalPixels comprises a total number of pixels for the SPAD array.

10. The method of claim 1, wherein a light signal comprises a photon.

11. The method of claim 1, further comprising relating the count of light signals to a property of a particle from which the light signals were emitted, the particle being a cell.

12. A flow cytometry system, comprising:
a plurality of lasers, wherein each laser of the plurality of lasers is configured to illuminate a particle at a corresponding interrogation site;
a first optical filter (i) positioned within a main optical pathway of illuminated emissions from the particle after excitation by the illumination originating from the plurality of lasers and (ii) configured to receive illuminated emissions from at least one laser of the plurality of lasers and redirect a first portion of the received illuminated emissions along a first auxiliary optical pathway; and
at least one detector array positioned and configured to receive illuminated emissions of the first auxiliary optical pathway.

13. The flow cytometry system of claim 12, wherein the first portion of the illuminated emissions is within a spectrum of wavelengths, wherein the at least one detector array comprises at least one region configured to receive a portion of the spectrum of wavelengths, and wherein a portion of the spectrum of wavelengths comprises a fluorescence channel.

14. The flow cytometry system of claim 13, wherein the at least one region comprises a pixel of the at least one detector array.

15. The flow cytometry system of claim 12, further comprising an optical detector positioned at an end of the main optical pathway and configured to collect illuminated emissions from the main optical pathway, and further configured to detect alignment of components of the main optical pathway.

16. The flow cytometry system of claim 12, further comprising a second optical filter (i) positioned along the auxiliary optical pathway and (ii) configured to redirect a second portion of the illuminated emissions from the plurality of lasers along a second auxiliary optical pathway.

17. The flow cytometry system of claim 12, further comprising a detector array positioned along the second auxiliary optical pathway and configured to receive illuminated emissions of the second auxiliary pathway, wherein the first auxiliary optical pathway and the second auxiliary optical pathway are received by the at least one detector array.

18. The flow cytometry system of claim 12, further comprising a scatter filter positioned along the main optical pathway and between the plurality of lasers and the at least one optical filter, wherein the scatter filter is configured to redirect side scatter signals of the illuminated emissions away from the main optical pathway.

19. The flow cytometry system of claim 12, wherein each of the plurality of lasers is configured to emit light at a different wavelength compared to the other lasers.

20. The flow cytometry system of claim 12, further comprising an objective lens configured to receive the illuminated emissions from each of the plurality of lasers and direct the illuminated emissions to the main optical pathway.
